(19) United States
(12) Patent Application Publication
(10) Pub. No.: US 2024/0386516 A1
(43) Pub. Date: Nov. 21, 2024

(54) SERVER APPARATUS AND METHOD FOR IMPROVING TRAVEL MAAS

(71) Applicant: TOYOTA JIDOSHA KABUSHIKI KAISHA, Toyota-shi (JP)

(72) Inventors: Yu NAGATA, Chofu-shi (JP); Shun HASHIMOTO, Kiyosu-shi (JP); Kota YAMAZAKI, Kasugai-shi (JP); Akane MASAKI, Nisshin-shi (JP); Wataru ETO, Nagoya-shi (JP); Makoto AKAHANE, Yokohama-shi (JP)

(73) Assignee: TOYOTA JIDOSHA KABUSHIKI KAISHA, Toyota-shi (JP)

(21) Appl. No.: 18/665,226

(22) Filed: May 15, 2024

(30) Foreign Application Priority Data
May 17, 2023 (JP) 2023-081835

(51) Int. Cl. G06Q 50/40; G06Q 30/0283

(52) U.S. Cl. CPC G06Q 50/40; G06Q 30/0283

(57) ABSTRACT

A server apparatus includes a communication interface configured to communicate with a terminal apparatus configured to request a service to dispatch a service staff or a service vehicle to a location in which a user vehicle is parked and supply an energy source to the user vehicle, and a controller configured to acquire status data indicating a status of the service staff or the service vehicle, adjust a fee for the service according to the status indicated by the acquired status data, and transmit fee data indicating the adjusted fee to the terminal apparatus via the communication interface.

### CROSS-REFERENCE TO RELATED APPLICATION

This application claims priority to Japanese Patent Application No. 2023-081835 filed on May 17, 2023, the entire contents of which are incorporated herein by reference.

### TECHNICAL FIELD

The present disclosure relates to a server apparatus and a method for improving travel MaaS.

### BACKGROUND

Patent Literature (PTL) 1 discloses a system to provide a service to charge vehicles on behalf of users and a service to dispatch power supply vehicles.

### CITATION LIST

### Patent Literature

PTL 1: JP 2020-107303 A
PTL 2: CN 109102105 A
PTL 3: CN 106157625 A

### SUMMARY

In both the service to charge vehicles on behalf of users and the service to dispatch power supply vehicles, it may not be possible to meet the demand for the service completely when the use of the service is concentrated in a particular area or a particular time period.

It would be helpful to make it easier to avoid the concentration of the use of services.

A server apparatus according to the present disclosure includes:
a communication interface configured to communicate with a terminal apparatus configured to request a service to dispatch a service staff or a service vehicle to a location in which a user vehicle is parked and supply an energy source to the user vehicle; and
a controller configured to:
   acquire status data indicating a status of the service staff or the service vehicle;
   adjust a fee for the service according to the status indicated by the acquired status data; and
   transmit fee data indicating the adjusted fee to the terminal apparatus via the communication interface.

According to the present disclosure, it is easier to avoid the concentration of the use of services.

### BRIEF DESCRIPTION OF THE DRAWINGS

In the accompanying drawings:

FIG. 1 is a diagram illustrating a configuration of a service provision system according to an embodiment of the present disclosure;

FIG. 2 is a block diagram illustrating a configuration of a server apparatus according to the embodiment of the present disclosure;

FIG. 3 is a block diagram illustrating a configuration of a terminal apparatus according to the embodiment of the present disclosure; and

FIG. 4 is a flowchart illustrating operations of the service provision system according to the embodiment of the present disclosure.

### DETAILED DESCRIPTION

An embodiment of the present disclosure will be described below, with reference to the drawings.

In the drawings, the same or corresponding portions are denoted by the same reference numerals. In the descriptions of the present embodiment, detailed descriptions of the same or corresponding portions are omitted or simplified, as appropriate.

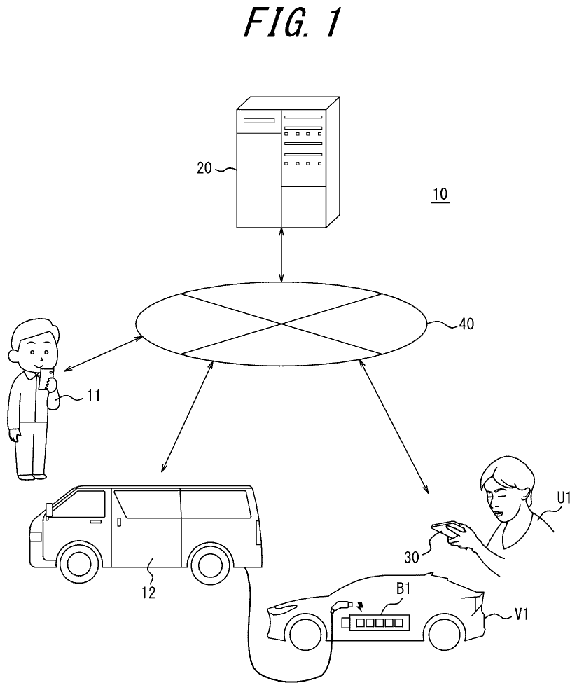

A configuration of a service provision system 10 according to the present embodiment will be described with reference to FIG. 1.

The service provision system 10 includes a server apparatus 20 and a terminal apparatus 30. The server apparatus 20 can communicate with the terminal apparatus 30 via a network 40. The server apparatus 20 may be able to communicate via the network 40 with a mobile device such as a mobile phone, smartphone, or tablet held by a service staff 11. The server apparatus 20 may be able to communicate via the network 40 with an in-vehicle device installed in a service vehicle 12 or a mobile device such as a mobile phone, smartphone, or tablet held by a staff on board the service vehicle 12. The terminal apparatus 30 may also be able to communicate via the network 40 with the mobile device held by the service staff 11, the in-vehicle device installed in the service vehicle 12, or the mobile device held by the staff on board the service vehicle 12.

The server apparatus 20 is a computer that belongs to a cloud computing system or other computing system installed in a facility such as a data center. The server apparatus 20 is operated by a supply service provider.

The terminal apparatus 30 is, for example, a mobile device such as a mobile phone, smartphone, or tablet held by each user. The terminal apparatus 30 executes a terminal program to request a supply service.

The supply service is a service to dispatch the service staff 11 or the service vehicle 12 to a location in which a user vehicle is parked and supply an energy source to the user vehicle. In the present embodiment, the user vehicle is a BEV. The term “BEV” is an abbreviation of battery electric vehicle. The energy source to be supplied to the user vehicle is electricity. As a variation of the present embodiment, the user vehicle may be another type of automobile such as a gasoline vehicle, a diesel vehicle, a hydrogen vehicle, an HEV, a PHEV, or an FCEV. The term “HEV” is an abbreviation of hybrid electric vehicle. The term “PHEV” is an abbreviation of plug-in hybrid electric vehicle. The term “FCEV” is an abbreviation of fuel cell electric vehicle. The user vehicle may be a MaaS-dedicated vehicle. The term “MaaS” is an abbreviation of Mobility as a Service. The energy source to be supplied to the user vehicle is not limited to electricity, and may be gasoline, diesel fuel, hydrogen, or the like.

The supply service includes at least a charging service or a battery replacement service, and includes both of the charging service and the battery replacement service in the present embodiment. The charging service is a service to supply the energy source to the user vehicle by charging a battery installed in the user vehicle. The battery replacement service is a service to supply the energy source to the user vehicle by replacing the battery installed in the user vehicle with another battery. As a variation of the present embodiment, the supply service may include a service to refuel the user vehicle.

The supply service includes at least an agent-type service or a mobile-type service, and includes both of the agent-type service and the mobile-type service in the present embodiment. The agent-type service is a service to dispatch the service staff 11 to the location in which the user vehicle is parked, have the dispatched service staff 11 move the user vehicle to another location, and supply the energy source to the user vehicle in the location to which the user vehicle is moved. The mobile-type service is a service to dispatch the service vehicle 12 to the location in which the user vehicle is parked and have the dispatched service vehicle 12 supply the energy source to the user vehicle in the location in which the user vehicle is parked.

In the present embodiment, one of the following combinations of services is selected by each user or automatically, and provided as the supply service: a combination of the charging service and the agent-type service, a combination of the battery replacement service and the agent-type service, a combination of the charging service and the mobile-type service, and a combination of the battery replacement service and the mobile-type service. In other words, in the present embodiment, the agent-type charging service, the agent-type battery replacement service, the mobile-type charging service, or the mobile-type battery replacement service is selectively provided.

For example, in the agent-type charging service, while a user U1 is not using a user vehicle V1, a worker as the service staff 11 drives the user vehicle V1 from a parking lot to a charging station, charges a battery B1 of the user vehicle V1, and then returns the user vehicle V1. In the agent-type battery replacement service, while the user U1 is not using the user vehicle V1, the worker as the service staff 11 drives the user vehicle V1 from the parking lot to a battery replacement station, replaces the battery B1 of the user vehicle V1 with another battery, and then returns the user vehicle V1. In the mobile-type charging service, a mobile charging vehicle as the service vehicle 12 comes to the parking lot, and charges the battery B1 of the user vehicle V1 on the spot. In the mobile-type battery replacement service, a mobile battery replacement vehicle as the service vehicle 12 comes to the parking lot, and replaces the battery B1 of the user vehicle V1 with another battery on the spot.

The network 40 includes the Internet, at least one WAN, at least one MAN, or any combination thereof. The term “WAN” is an abbreviation of wide area network. The term “MAN” is an abbreviation of metropolitan area network. The network 40 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation of local area network.

An outline of the present embodiment will be described with reference to FIG. 1.

The server apparatus 20 acquires status data. The status data is data indicating the status of the service staff 11 or the service vehicle 12. The “status” includes the position of the service staff 11 or the service vehicle 12 in the present embodiment, but may include whether the service staff 11 is in operation, or whether the service vehicle 12 is in operation. The server apparatus 20 adjusts a fee for the supply service according to the status indicated by the acquired status data. The server apparatus 20 transmits fee data to the terminal apparatus 30. The fee data is data indicating the adjusted fee. Upon receiving the fee data from the server apparatus 20, the terminal apparatus 30 presents the fee indicated by the fee data to a user.

According to the present embodiment, it is easier to avoid the concentration of the use of the supply service. Therefore, it is easier to meet the demand for the supply service. For example, in order to promote efficient use of the supply service, a lower fee may be presented to the user U1 when the user vehicle V1 is parked in a parking lot that is located near the current location of the worker as the service staff 11 or the current location of the mobile charging vehicle or the mobile battery replacement vehicle as the service vehicle 12. Alternatively, a lower fee may also be presented to the user U1 when the user vehicle V1 is parked in a parking lot that is located near the position where the worker, who is providing the service, should be at the end of the service provision or the position where the mobile charging vehicle or the mobile battery replacement vehicle, which is providing the service, should be at the end of the service provision. Alternatively, a lower fee may also be presented to the user U1 when the worker, or the mobile charging vehicle or the mobile battery replacement vehicle is not in operation regardless of where the user vehicle V1 is parked.

In an example, the server apparatus 20 may be used to provide MaaS, a service that leverages mobility.

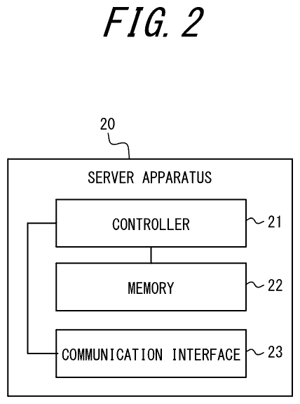

A configuration of the server apparatus 20 according to the present embodiment will be described with reference to FIG. 2.

The server apparatus 20 includes a controller 21, a memory 22, and a communication interface 23.

The controller 21 includes at least one processor, at least one programmable circuit, at least one dedicated circuit, or any combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to operations of the server apparatus 20 while controlling components of the server apparatus 20.

The memory 22 includes at least one semiconductor memory, at least one magnetic memory, at least one optical memory, or any combination thereof. The semiconductor memory is, for example, RAM, ROM, or flash memory. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The flash memory is, for example, SSD. The term “SSD” is an abbreviation of solid-state drive. The magnetic memory is, for example, HDD. The term “HDD” is an abbreviation of hard disk drive. The memory 22 functions as, for example, a main memory, an auxiliary memory, or a cache memory. The memory 22 stores data to be used for operations of the server apparatus 20 and data obtained by the operations of the server apparatus 20.

The communication interface 23 includes at least one communication module. The communication module is, for example, a module compatible with a wired LAN communication standard such as Ethernet® (Ethernet is a registered trademark in Japan, other countries, or both) or a wireless LAN communication standard such as IEEE802.11. The name “IEEE” is an abbreviation of Institute of Electrical and Electronics Engineers. The communication interface 23 communicates with the terminal apparatus 30. The communication interface 23 may communicate with the mobile device held by the service staff 11. The communication interface 23 may communicate with the in-vehicle device installed in the service vehicle 12 or the mobile device held by the staff on board the service vehicle 12. The communication interface 23 receives data to be used for the operations of the server apparatus 20, and transmits data obtained by the operations of the server apparatus 20.

The functions of the server apparatus 20 are realized by execution of a server program according to the present embodiment by a processor serving as the controller 21. That is, the functions of the server apparatus 20 are realized by software. The server program causes a computer to execute the operations of the server apparatus 20, thereby causing the computer to function as the server apparatus 20. That is, the computer executes the operations of the server apparatus 20 in accordance with the server program to thereby function as the server apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the server apparatus 20 may be realized by a programmable circuit or a dedicated circuit serving as the controller 21. That is, some or all of the functions of the server apparatus 20 may be realized by hardware.

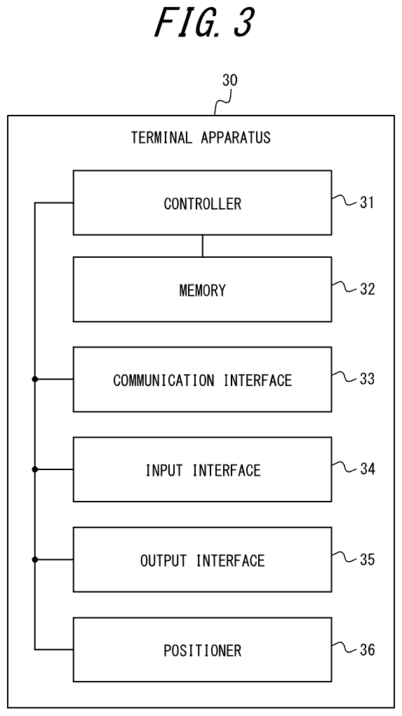

A configuration of the terminal apparatus 30 according to the present embodiment will be described with reference to FIG. 3.

The terminal apparatus 30 includes a controller 31, a memory 32, a communication interface 33, an input interface 34, an output interface 35, and a positioner 36.

The controller 31 includes at least one processor, at least one programmable circuit, at least one dedicated circuit, or any combination thereof. The processor is a general purpose processor such as a CPU or a GPU, or a dedicated processor that is dedicated to specific processing. The programmable circuit is, for example, an FPGA. The dedicated circuit is, for example, an ASIC. The controller 31 executes processes related to operations of the terminal apparatus 30 while controlling components of the terminal apparatus 30.

The memory 32 includes at least one semiconductor memory, at least one magnetic memory, at least one optical memory, or any combination thereof. The semiconductor memory is, for example, RAM, ROM, or flash memory. The RAM is, for example, SRAM or DRAM. The ROM is, for example, EEPROM. The flash memory is, for example, SSD. The magnetic memory is, for example, HDD. The memory 32 functions as, for example, a main memory, an auxiliary memory, or a cache memory. The memory 32 stores data to be used for the operations of the terminal apparatus 30 and data obtained by the operations of the terminal apparatus 30.

The communication interface 33 includes at least one communication module. The communication module is, for example, a module compatible with a mobile communication standard such as LTE, the 4G standard, or the 5G standard, a wireless LAN communication standard such as IEEE802.11. The term “LTE” is an abbreviation of Long Term Evolution. The term “4G” is an abbreviation of 4th generation. The term “5G” is an abbreviation of 5th generation. The communication interface 33 communicates with the server apparatus 20. The communication interface 33 may communicate with the mobile device held by the service staff 11. The communication interface 33 may communicate with the in-vehicle device installed in the service vehicle 12 or the mobile device held by the staff on board the service vehicle 12. The communication interface 33 receives data to be used for the operations of the terminal apparatus 30, and transmits data obtained by the operations of the terminal apparatus 30.

The input interface 34 is, for example, a physical key, a capacitive key, a pointing device, a touch screen integrally provided with a display, a visible light camera, a LiDAR sensor, or a microphone. The term “LiDAR” is an abbreviation of light detection and ranging. The input interface 34 accepts an operation for inputting data to be used for the operations of the terminal apparatus 30. The input interface 34, instead of being included in the terminal apparatus 30, may be connected to the terminal apparatus 30 as an external input device. As an interface for connection, an interface compliant with a standard such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface.

The output interface 35 is, for example, a display or a speaker. The display is, for example, an LCD or an organic EL display. The term “LCD” is an abbreviation of liquid crystal display. The term “EL” is an abbreviation of electro luminescent. The output interface 35 outputs data obtained by the operations of the terminal apparatus 30. The output interface 35, instead of being included in the terminal apparatus 30, may be connected to the terminal apparatus 30 as an external output device. As an interface for connection, an interface compliant with a standard such as USB, HDMI® (HDMI is a registered trademark in Japan, other countries, or both), or Bluetooth® (Bluetooth is a registered trademark in Japan, other countries, or both) can be used.

The positioner 36 includes at least one GNSS receiver. The term “GNSS” is an abbreviation of global navigation satellite system. GNSS is, for example, GPS, QZSS, BDS, GLONASS, or Galileo. The term “GPS” is an abbreviation of Global Positioning System. The term “QZSS” is an abbreviation of Quasi-Zenith Satellite System. QZSS satellites are called quasi-zenith satellites. The term “BDS” is an abbreviation of BeiDou Navigation Satellite System. The term “GLONASS” is an abbreviation of Global Navigation Satellite System. The positioner 36 measures the position of the terminal apparatus 30.

The functions of the terminal apparatus 30 are realized by execution of the terminal program according to the present embodiment by a processor serving as the controller 31. That is, the functions of the terminal apparatus 30 are realized by software. The terminal program causes a computer to execute the operations of the terminal apparatus 30, thereby causing the computer to function as the terminal apparatus 30. That is, the computer executes the operations of the terminal apparatus 30 in accordance with the terminal program to thereby function as the terminal apparatus 30.

Some or all of the functions of the terminal apparatus 30 may be realized by a programmable circuit or a dedicated circuit serving as the controller 31. That is, some or all of the functions of the terminal apparatus 30 may be realized by hardware.

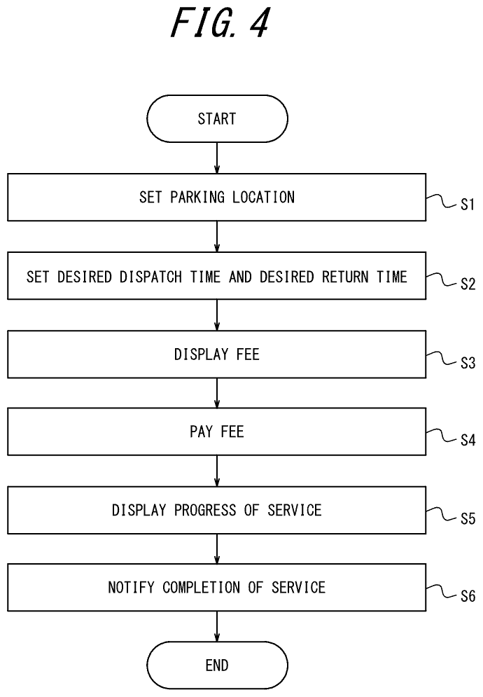

With reference to FIG. 4, operations of the service provision system 10 according to the present embodiment will be described. The operations described below correspond to a service provision method according to the present embodiment. In other words, the service provision method according to the present embodiment includes steps S1 through S6 illustrated in FIG. 4.

When a user U1 starts the terminal program to request the supply service or selects a specific item such as “request service” on a menu screen of the terminal program, step S1 is executed.

In S1, the controller 31 of the terminal apparatus 30 accepts, via the input interface 34, a first user operation to specify a parking location. In the first user operation, not only is the parking location specified, but also information regarding the details of the parking location may be input. The information to be input may include, for example, the name of a building when the parking location is in or adjacent to the building. The information to be input may include information on a parking lot, such as whether the parking lot is on the ground, on the basement, or with a roof, or a parking lot number. The information to be input may include, for example, a photograph of the area around the user vehicle V1 when the user U1 has already parked the user vehicle V1 in the parking location.

In S2, the controller 31 of the terminal apparatus 30 accepts, via the input interface 34, a second user operation to input a desired dispatch time and a desired return time. The desired dispatch time corresponds to the time when the service staff 11 picks up the user vehicle V1, as desired by the user U1 in the case of the agent-type service. The desired dispatch time corresponds to the time when the service vehicle 12 arrives in the vicinity of the user vehicle V1, as desired by the user U1 in the case of the mobile-type service. The desired return time corresponds to the time when the service staff 11 returns the user vehicle V1 after charging or battery replacement, as desired by the user U1 in the case of the agent-type service. The desired return time corresponds to the time when the service vehicle 12 completes charging or battery replacement of the user vehicle V1, as desired by the user U1 in the case of the mobile-type service.

In S3, the controller 21 of the server apparatus 20 acquires status data. Specifically, the controller 21 of the server apparatus 20 collects the status data via the communication interface 23 from the mobile device held by the service staff 11, the in-vehicle device installed in the service vehicle 12, or the mobile device held by the staff on board the service vehicle 12. The status data is data indicating the status of the service staff 11 or the service vehicle 12. The controller 21 of the server apparatus 20 adjusts the fee for the supply service according to the status indicated by the acquired status data. The controller 21 of the server apparatus 20 transmits fee data to the terminal apparatus 30 via the communication interface 23. The fee data is data indicating the adjusted fee. Upon receiving the fee data from the server apparatus 20 via the communication interface 33, the controller 31 of the terminal apparatus 30 presents the fee indicated by the fee data to the user U1. Specifically, the controller 31 of the terminal apparatus 30 displays the fee indicated by the fee data on a display serving as the output interface 35.

In the present embodiment, the status indicated by the status data includes the position of the service staff 11 or the service vehicle 12. The controller 21 of the server apparatus 20 adjusts the fee for the supply service according to the closeness between the position indicated by the status data and the position of the user vehicle V1. The position of the service staff 11 is not limited to the current location of the worker as the service staff 11, and may be the position where the worker, who is providing the service, should be at the end of the service provision. Similarly, the position of the service vehicle 12 is not limited to the current location of the mobile charging vehicle or the mobile battery replacement vehicle as the service vehicle 12, and may be the position where the mobile charging vehicle or the mobile battery replacement vehicle, which is providing the service, should be at the end of the service provision. The position of the user vehicle V1 is the parking location specified by the first user operation in S1. For example, the controller 21 of the server apparatus 20 sets a lower fee for the supply service when the user vehicle V1 is parked in a parking lot that is located near the current location of the worker or the current location of the mobile charging vehicle or the mobile battery replacement vehicle. Alternatively, the controller 21 of the server apparatus 20 may set a lower fee for the supply service when the user vehicle V1 is parked in a parking lot that is located near the position where the worker, who is providing the service, should be at the end of the service provision or the position where the mobile charging vehicle or the mobile battery replacement vehicle, which is providing the service, should be at the end of the service provision.

The status indicated by the status data may include whether the service staff 11 is in operation, or whether the service vehicle 12 is in operation. For example, the controller 21 of the server apparatus 20 may set a lower fee for the supply service when the worker, or the mobile charging vehicle or the mobile battery replacement vehicle is not in operation.

The controller 21 of the server apparatus 20 may predict demand for the supply service in a plurality of periods. Any method of demand prediction, such as statistical analysis or machine learning, can be used. The controller 21 of the server apparatus 20 may set the fee for the supply service in a non-congested period prior to a congested period in which the predicted demand exceeds a threshold, among the plurality of periods, lower than the fee for the supply service in the congested period. For example, the controller 21 of the server apparatus 20 may discount the fee during the period prior to a period when increased demand is expected, such as by halving the fee on weekdays prior to a three-day holiday weekend.

The controller 21 of the server apparatus 20 may generate proposal data with reference to the prediction result obtained by predicting the demand for the supply service in the plurality of periods and schedule data. The schedule data is data indicating a schedule of the user U1. The proposal data is data proposing in which period the supply service should be used, among the plurality of periods. The controller 21 of the server apparatus 20 may transmit the generated proposal data to the terminal apparatus 30 via the communication interface 23. Upon receiving the proposal data from the server apparatus 20 via the communication interface 33, the controller 31 of the terminal apparatus 30 presents the contents of the proposal data to the user U1. For example, the controller 21 of the server apparatus 20 may predict the demand for the supply service for each day of the week, such as weekdays and weekends and holidays. Alternatively, the controller 21 of the server apparatus 20 may predict the demand for the supply service at different times of the day, such as morning, midday, evening, and midnight. If the user U1 is a bus operator, the controller 21 of the server apparatus 20 may determine whether charging is required with reference to the bus operation schedule. If charging is necessary, the controller 21 of the server apparatus 20 may propose a charging plan that avoids combinations of days and times when the use of the charging service is concentrated.

The controller 21 of the server apparatus 20 may limit the days and times when charging or battery replacement is available depending on the subscription plan that the user U1 has signed up for. Subscription plans include, for example, weekday-only or midnight-only plans.

The controller 21 of the server apparatus 20 may further adjust the fee for the supply service depending on which day of the week and which time of day the desired dispatch time and desired return time entered by the second user operation in S2 are. For example, late at night, labor costs are higher, so fees may be set higher.

Steps S1 through S3 may be repeated until the user U1 agrees to pay the fee presented in S3.

In S4, upon accepting, via the input interface 34, a third user operation to pay for the supply service, the controller 31 of the terminal apparatus 30 transmits request data to the server apparatus 20 via the communication interface 33. The request data is data requesting the supply service with indication of the parking location that is specified by the first user operation in S1. In the present embodiment, the request data includes data indicating the desired dispatch time and the desired return time input by the second user operation in S2. Upon receiving the request data from the terminal apparatus 30 via the communication interface 23, the controller 21 of the server apparatus 20 automatically processes payment for the supply service according to the received request data. Once the automatic process of payment is completed, the controller 21 of the server apparatus 20 performs a process of dispatching the service staff 11 or the service vehicle 12 to the parking location indicated by the request data. Specifically, the controller 21 of the server apparatus 20 notifies, of the request data, a manager who selects the type of the supply service according to the positional relationship between the service staff 11 or service vehicle 12 and the parking location and dispatches the service staff 11 or service vehicle 12 to the parking location. Alternatively, the controller 21 of the server apparatus 20 may automatically select the type of the supply service according to the positional relationship between the service staff 11 or service vehicle 12 and the parking location, and dispatch the service staff 11 or service vehicle 12 to the parking location. For example, when the distance or time required from the position of a worker, as the service staff 11, to the parking location is less than or equal to a threshold value, the controller 21 of the server apparatus 20 may transmit first instruction data via the communication interface 23 to a mobile device held by the worker. When the distance or time required from the position of a mobile charging vehicle, as the service vehicle 12, to the parking location is less than or equal to a threshold value, the controller 21 of the server apparatus 20 may transmit second instruction data via the communication interface 23 to an in-vehicle device installed in the mobile charging vehicle or a mobile device held by a worker on board the mobile charging vehicle. When the distance or time required from the position of a mobile battery replacement vehicle, as the service vehicle 12, to the parking location is less than or equal to a threshold value, the controller 21 of the server apparatus 20 transmits third instruction data via the communication interface 23 to an in-vehicle device installed in the mobile battery replacement vehicle or a mobile device held by a worker on board the mobile battery replacement vehicle. The first instruction data is data that instructs the worker to provide the agent-type charging service. Alternatively, the first instruction data may be data that instructs the worker to provide the agent-type battery replacement service. The second instruction data is data that instructs the mobile charging vehicle or the worker on board the mobile charging vehicle to provide the mobile-type charging service. The third instruction data is data that instructs the mobile battery replacement vehicle or the worker on board the mobile battery replacement vehicle to provide the mobile-type battery replacement service. The first, second, and third instruction data may include the information regarding the details of the parking location. The first, second, and third instruction data may include the data indicating the desired dispatch time and the desired return time.

In S5, the controller 21 of the server apparatus 20 monitors the progress of the supply service. When the type of the supply service selected in S4 is the agent-type charging service or the agent-type battery replacement service, the controller 21 of the server apparatus 20 monitors the progress by communicating via the communication interface 23 with the mobile device held by the worker. When the type of the supply service selected in S4 is the mobile-type charging service, the controller 21 of the server apparatus 20 monitors the progress by communicating via the communication interface 23 with the in-vehicle device installed in the mobile charging vehicle or the mobile device held by the worker on board the mobile charging vehicle. When the type of the supply service selected in S4 is the mobile-type battery replacement service, the controller 21 of the server apparatus 20 monitors the progress by communicating via the communication interface 23 with the in-vehicle device installed in the mobile battery replacement vehicle or the mobile device held by the worker on board the mobile battery replacement vehicle. The controller 21 of the server apparatus 20 notifies the terminal apparatus 30 of the progress via the communication interface 23. The controller 31 of the terminal apparatus 30 displays the progress to the display as the output interface 35.

In S6, upon detecting completion of the supply service, the controller 21 of the server apparatus 20 notifies the terminal apparatus 30 of the completion via the communication interface 23. The controller 31 of the terminal apparatus 30 displays a screen indicating that the supply service has been completed, on the display as the output interface 35. In this screen, when the type of the supply service selected in S4 is the agent-type charging service or the agent-type battery replacement service, information regarding a position in which the worker has parked the user vehicle V1 may be displayed. A photograph of the user vehicle V1 taken by the worker may be displayed.

In an example, the above processing steps may be executed when providing a service (MaaS) using the server apparatus 20. In this case, the information processing method according to the above processing steps is an example of a method of providing a service (MaaS) using the server apparatus 20.

The present disclosure is not limited to the embodiment described above. For example, two or more blocks described in the block diagrams may be integrated, or a block may be divided. Instead of executing two or more steps described in the flowcharts in chronological order in accordance with the description, the steps may be executed in parallel or in a different order according to the processing capability of the apparatus that executes each step, or as required. Other modifications can be made without departing from the spirit of the present disclosure.

1. A server apparatus comprising:
a communication interface configured to communicate with a terminal apparatus configured to request a service to dispatch a service staff or a service vehicle to a location in which a user vehicle is parked and supply an energy source to the user vehicle; and
a controller configured to:
acquire status data indicating a status of the service staff or the service vehicle;
adjust a fee for the service according to the status indicated by the acquired status data; and
transmit fee data indicating the adjusted fee to the terminal apparatus via the communication interface.

2. The server apparatus according to claim 1, wherein
the status includes a position of the service staff or the service vehicle, and
the controller is configured to adjust the fee for the service according to closeness between the position indicated by the status data and a position of the user vehicle.

3. The server apparatus according to claim 1, wherein the status includes whether the service staff is in operation, or whether the service vehicle is in operation.

4. The server apparatus according to claim 1, wherein the controller is configured to:
predict demand for the service in a plurality of periods; and
set a fee for the service in a non-congested period prior to a congested period in which the predicted demand exceeds a threshold, among the plurality of periods, lower than a fee for the service in the congested period.

5. The server apparatus according to claim 1, wherein the controller is configured to:
predict demand for the service in a plurality of periods;
generate proposal data proposing in which period the service should be used, among the plurality of periods, with reference to an obtained prediction result and schedule data indicating a schedule of a user; and
transmit the generated proposal data to the terminal apparatus via the communication interface.

6. A method, by a processor, for improving travel mobility as a service (MaaS), comprising processing steps executed by the server apparatus according to claim 1.
